(19) United States
(12) Patent Application Publication
(10) Pub. No.: US 2018/0345410 A1
(43) Pub. Date: Dec. 6, 2018

(54) DEVICE AND METHOD FOR PRODUCING A THREE-DIMENSIONAL, SHAPED METAL BODY

(71) Applicant: Marco WERLING, Rheinzabern (DE)

(72) Inventor: Marco WERLING, Rheinzabern (DE)

(21) Appl. No.: 15/778,243

(22) PCT Filed: Nov. 25, 2016
(86) PCT No.: PCT/DE2016/100551

§ 371 Date: May 23, 2018

(30) Foreign Application Priority Data
Dec. 9, 2015 (DE) 10 2015 121 437.7

(51) Int. Cl. B23K 26/342; B33Y 10/00; B33Y 30/00; B23K 26/03; B23K 26/06; B23K 26/08; B23K 26/14

(52) U.S. Cl. CPC B23K 26/342; B33Y 10/00; B33Y 30/00; B23K 26/1464; B23K 26/0613; B23K 26/0869; B23K 26/032

(57) ABSTRACT

Metal field 3D printers discharge metal powder over a base plate and a directable laser subsequently welds relevant points. Iteration layer-by-layer results in a shaped body which is printed using a computer model as an individual piece for rapid prototyping. The metal powder discharge, subsequent welding and final multiple iteration, however, take time, making shaped body production time-consuming. A more rapid movement of the carriage does not accelerate the process, because of metal powder turbulence occurring in the metal powder. To solve this problem, a laser is carried along on the carriage such that the welding process can be carried out directly with the passing over of the carriage. Therefore, the carriage travels more rapidly without risking turbulence and multiple layer applications are thus possible in one pass, in particular by arranging parallel laser elements and material chambers across the whole carriage width passing over the base plate.

The present invention relates to an apparatus for the production of a three-dimensional metallic shaped body, comprising a base plate that can be adjusted in height relative to a carriage, a carriage guide, a carriage that runs in this carriage guide, traversing the base plate, having at least one material chamber for discharge of metal powder above the base plate, and at least one laser element for melting of discharged metal powder at certain points, wherein the carriage has laser elements and material chambers that alternate in the movement direction of the carriage, in an alternating sequence, as well as to a corresponding method for the production of a metallic shaped body.

Such a solution is already previously known from EP 2 502 729 A1. There, metal powder is presented to a point-shaped laser beam from two adjacent chambers which powder the laser is then able to fuse together with a layer that lies underneath so that the desired shape is formed. This has the advantage that material is applied only where it is needed. However, it is problematical, in this regard, that the newly applied metal powder will trickle down, specifically in the case of narrow and growing structures, so that it is necessary either to apply a uniform layer with a point-shaped distribution in a complicated movement over the entire construction space and to use the laser only at the desired points, or to add a metal powder layer in a different process after a layer has been applied, and this cancels out the speed advantages of the present solution.

DE 10 2007 029 142 A1, in contrast, provides for area-wide application of metal powder, wherein uniformization of the powder layer is supposed to be achieved by application of a voltage.

An adjustment apparatus, with which a laser for melting the metal powder can be deflected, is known from DE 10 2008 000 030 A1.

U.S. Pat. No. 5,993,554 A again describes a central, point-shaped laser, to which the metal powder is presented by way of multiple feeds.

The traditional way of producing a three-dimensional metallic shaped body consists in carving the shaped body out of a larger workpiece by means of a severing method such as chipping or ablation, for example, and removing the parts that are not required during this process. However, the work steps required for this suggest a design that is really free only within certain limits. Curved boreholes, undercuts, and cavities are only possible under certain conditions, and generally require the shaped body to be composed of multiple individual parts.

What are called additive methods represent a solution for this problem; in these methods, the shaped bodies to be produced are formed not by means of removing superfluous parts, but rather by means of building the desired parts up layer by layer. In the method of what is called multi-jet modeling, a print head having multiple jets, for example, moves over an object to be produced and applies individual droplets of a moldable material, for example plastic, at the desired location, and this material then hardens there. Hardening can take place by means of UV irradiation, for example.

What is called stereolithography works with building up an object to be produced, in a liquid plastic bath, wherein the workpiece is lowered into the liquid, in each instance, and raised to such an extent that a suitable layer thickness remains lying on the workpiece. The liquid plastic is uniformly distributed on the workpiece using a wiper, and then hardened, using a light beam, at the points to be built up, in such a manner that the workpiece is built up layer by layer.

The work proceeds in similar manner to this method in the additive construction of metallic shaped bodies that was addressed initially, in which a metal powder is filled up over the workpiece in thin layers, in place of a liquid plastic, and the uppermost layer, in each instance, is melted using a laser beam, for example, at the desired locations, and fused together with a layer that lies underneath.

For this purpose, the method of procedure can be such, for example, that metal powder is ejected by way of a lifting system and applied over the construction region using a distribution instrument, for example in the form of a doctor blade or a wiper whereupon a laser impacts the newly distributed powder layer in such a manner that the points intended for the planned layer are fused and thereby the next layer is built up on the workpiece. Contingent upon the material, application of a layer therefore requires rather significant time expenditure, since the entire construction space must be traversed by the distribution instrument at least once. In this regard, the speed cannot be increased in just any desired manner, due to the inertia of the powder material, because otherwise, turbulence of the material will occur, and non-uniform application of the material layers will lead to defects in the workpiece.

Based on the time required for production of individual workpieces, such a method is particularly well suited for what is called Rapid Prototyping, since an individual piece shaped in any desired manner can be produced with relatively little effort, without the production of tools. However, due to the rather great time expenditure in relation to industrial mass production, in this regard, such methods, in the known configuration, are only suitable for long-term production of products in individual cases.

Proceeding from this, the present invention is based on the task of improving known apparatuses and methods for the production of a three-dimensional metallic shaped body to the effect that the production procedure is significantly accelerated and thereby the known methods become more attractive for the production of large quantities of products.

This is accomplished by an apparatus for the production of a three-dimensional metallic shaped body in accordance with the characteristics of claim 1. Likewise, this is accomplished by a method for the production of such a shaped body in accordance with the characteristics of the other independent claim 7. Practical embodiments of this apparatus and of the method can be derived from the associated dependent claims, in each instance.

According to the invention, it is provided that similar to the state of the art, a layer composed of metal powder is discharged above a base plate. This is done using a carriage that is adjustable in height relative to the base plate, in other words is either held in a height-adjustable carriage guide or runs above a height-adjustable base plate. For this purpose, the carriage has one or more material chambers from which the metal powder is discharged above the base plate. Furthermore, the carriage has at least one laser element, with which the discharged metal powder can be melted at certain points and fused to the surface that lies underneath.

Because of the fact that the laser element is disposed directly on the carriage, it is possible to move the carriage with the metal powder to be discharged more rapidly, and to carry out fusing of the discharged metal powder directly behind it, line by line. This leads to the result that immediately after reaching an end point, the carriage can be moved back once again. A waiting period at the end point, until completion of the laser procedure, is eliminated.

Furthermore, a second material chamber can be associated with the carriage, so that material chambers and laser elements alternate in strips. This makes it possible to operate the carriage in both directions in the case of an arrangement with two material chambers and a laser element that lies between them, as an example, and, in this regard, to carry out complete material application and a fusing procedure during travel over the base plate in each direction. In this regard, a material chamber that lies in front in the direction of travel will discharge the metal powder contained in it first, onto the existing metal powder layer and onto the top edge of the workpiece, and afterward, the laser element that lies directly behind the first material chamber that lies in front immediately fuses the metal powder that has just been discharged onto the workpiece at the points intended for this. During this process, a second material chamber can apply a further material layer during the same pass, wherein subsequently, a further laser element can follow. This configuration can be repeated as often as desired, wherein it is provided, in particular, to dispose a material chamber at the end, so as to be able to operate the carriage also in reverse, on the way back, as described above.

The laser elements are preferably structured, in detail in such a manner that they are able to cover a complete width of the base plate. For this purpose, the laser elements can have one or more lasers and deflection mirrors, if needed, with which all the points present below the laser line can be reached. By means of placement of multiple lasers below the carriage, it is possible to increase the working speed in that a laser is assigned to a specific section, in each instance. The smaller the sections that are assigned to an individual laser, the faster the carriage can be moved above the base plate.

In general, the lasers are controlled by way of a process computer, which has stored the plan of a 3D model of the workpiece to be produced, built up layer by layer, in memory. In this regard, the process computer issues the commands for line-by-line control of the lasers, wherein the lasers are either themselves adjustable to reach the desired points, in each instance, or, alternatively, work with deflection mirrors, which in turn are so mobile that every point in the range of a laser can be reached by it.

It is quite advantageous if the material chambers are formed in such a manner that one or more material chambers are situated in a line, in each instance, which extends over the entire width of the carriage and with which chambers uniform discharge of the metal power is made possible, layer by layer. In order to achieve uniform discharge of the metal powder vibration elements can be associated with the material chambers, which elements make the material discharge uniform. Not only piezoelectric vibration elements but also eccentric elements or other activators usually suitable and used for this purpose are suitable as such vibration elements.

To some advantage, an imaging device is assigned to the region of each laser element, which device records an image recording of the region covered by the lasers. By way of this device, evaluations can be conducted as to whether a fusing procedure was carried out correctly and, in this regard, quality assurance can be performed.

Finally, it is also possible to supplementally provide the lasers known in the state of the art and disposed at the top in the housing, so that in the case of material discharge by the carriage, the last material chamber, in the direction of travel, also discharges material above the base plate, wherein this material layer that was discharged last can then be fused by the further laser elements that lie at the top.

In this regard, the production method for a three-dimensional metallic shaped body has an appearance such that first, a layer composed of metal powder is discharged over a base plate. If the base plate itself is not supposed to be part of the workpiece, multiple powder layers can be discharged as a base, and a first fusing process by the lasers can be started only at some height above the base plate. If, in contrast, the base plate is supposed to be connected with the workpiece, the first metal powder layer can be directly fused to the base plate at certain points.

In the same manner, metal powder layers are discharged using the carriage, layer by layer, and the points that belong to the workpiece in every layer are fused by the laser elements associated with the carriage immediately after discharge of the metal powder. Multiple layers of metal powder can be applied and fused during a pass of the carriage.

After every pass of the carriage during which discharge of a metal powder layer takes place, the distance between the carriage and the base plate is increased in height, either in that the carriage is raised or, alternatively, that the base plate is lowered. After a complete construction procedure, the workpiece is removed, with or without the base plate, and freed of the non-fused metal powder. What remains is the workpiece constructed in accordance with the plan in the memory of the process computer.

The invention described above will be explained in greater detail below, using an exemplary embodiment.

The figures show:

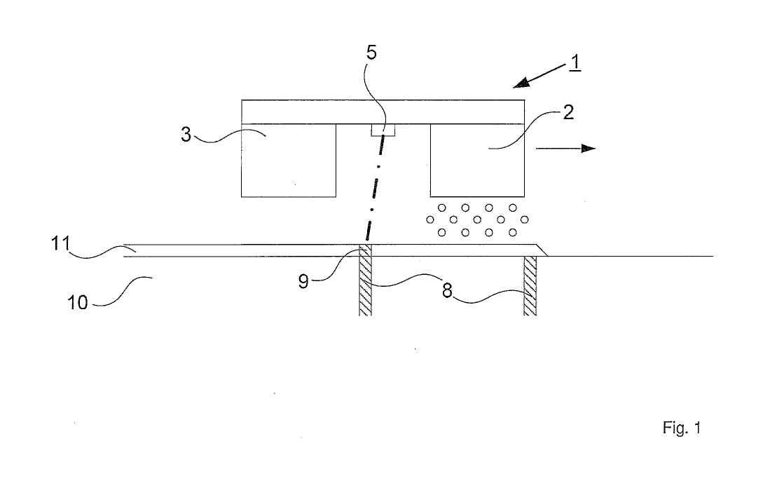

FIG. 1, an apparatus for the production of a three-dimensional metallic shaped body in a lateral cross-sectional representation,

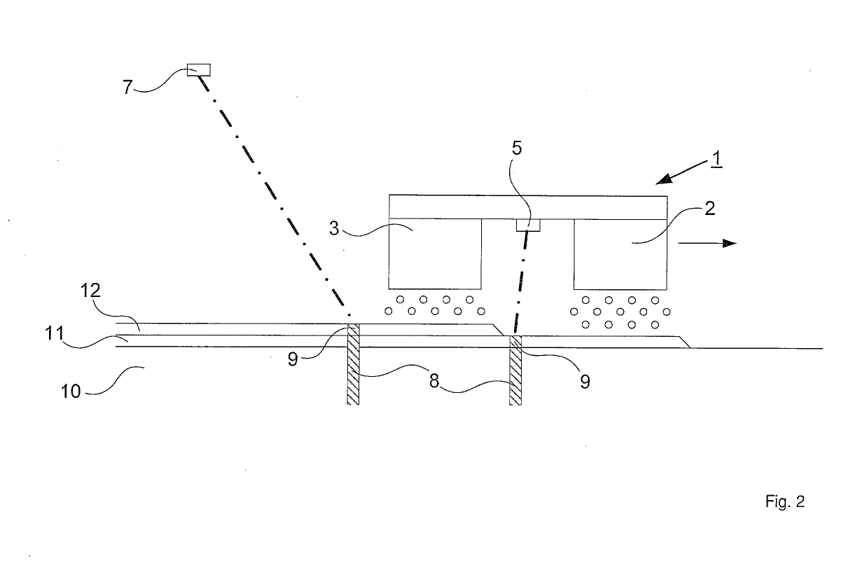

FIG. 2, an alternative apparatus for the production of a three-dimensional metallic shaped body in a lateral cross-sectional representation, and

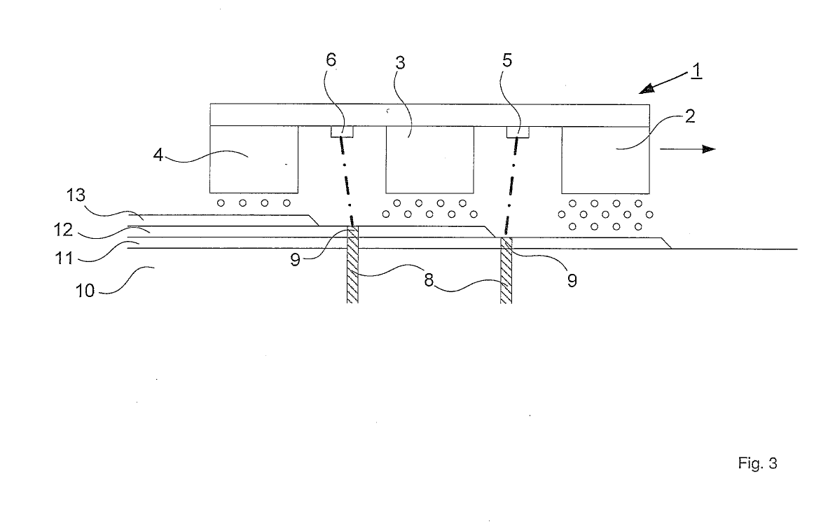

FIG. 3, a further alternative apparatus for the production of a three-dimensional metallic shaped body in a lateral cross-sectional representation.

FIG. 1 shows an apparatus for the production of a three-dimensional metallic shaped body 8, which is produced, layer by layer, by means of laser sintering of a metal powder. The metal powder is applied layer by layer, wherein those points of a layer that are supposed to be connected with a workpiece 8 are melted at a fusing point 9 and fused to the workpiece 8. However, due to the uniform application of metal powder, the workpiece 8 keeps sinking further into the metal powder during this process, while only the uppermost edges continue to remain visible and accessible. The workpiece 8 is situated, in this regard, in the older metal powder layers 10 while a first metal powder layer 11 is being discharged from a first material chamber 2 of a carriage 1 at the moment being considered. In this regard, the carriage 1 moves in the direction of the arrow shown to the right of the carriage 1, and discharges metal powder from the material chamber 2, wherein a fusing point 9 is set in the first metal powder layer 11 immediately after application of the first metal powder layer 11. This is done using a first laser element 5 which is disposed on the carriage 1 between the first material chamber 2 and the second material chamber 3.

After an end point is reached, a second metal powder layer is applied to the first metal powder layer 11, using a second material chamber 3, during the return path of the carriage in the opposite direction of movement on this first metal powder layer 11, and is also fused at a fusing point, using the first laser element 5.

FIG. 2 shows an alternative to the aforementioned solution, in which a first material chamber 2 and a second material chamber 3 are also present, but in deviation from the aforementioned method, both material chambers 2, 3 used at the same time. A first metal powder layer 11 discharged from the first material chamber 2 is fused at the desired locations at the required fusing points 9 by the laser element 5, wherein the carriage 1 practically pulls a second metal powder layer 12 discharged from the second material chamber 3 along behind it. The fusing points 9 to be made in the second metal powder layer 12 are fused from an elevated laser element 7, as was provided in the state of the art. Although the carriage might have to wait at the end point in this configuration, at least two instead of just one metal powder layer 11, 12 are discharged in this way, in one pass, and thereby the speed of the method is clearly increased.

FIG. 3 shows a consistent further development of the aforementioned exemplary solutions, with a carriage 1 having three material chambers 2, 3, 4, which in total discharge three metal powder layers 11, 12, 13. Fusing is undertaken by the laser elements 5, 6 between the material application of two adjacent layers; the last material chamber can optionally be reserved for the return path, according to the principle of the example in FIG. 1, or can apply a layer for an elevated laser element 7, which sets fusing points behind the carriage 1. In this regard, practically any expansion of the carriage 1 can be implemented, wherein material chambers and laser elements that can also be individually adjusted in height can be provided when using large layer thicknesses and application of very numerous layers per pass.

What is described above is an apparatus and a method for the production of a three-dimensional metallic shaped body, wherein one or more laser elements as well as one or more material chambers are carried along on the carriage, in order to perform as many work procedures as possible at the same time, even while the carriage is still moving, and thereby to save valuable time in the layer-by-layer construction of the workpiece.

### REFERENCE SYMBOL LIST

1. carriage
2. first material chamber
3. second material chamber
4. third material chamber
5. first laser element
6. second laser element
7. elevated laser element
8. workpiece
9. fusing point
10. older metal powder layers
11. first metal powder layer
12. second metal powder layer
13. third metal powder layer

1. Apparatus for the production of a three-dimensional metallic shaped body, comprising a base plate that can be adjusted in height relative to a carriage (1), a carriage guide, a carriage (1) that runs in this carriage guide, traversing the base plate, having at least one material chamber (2, 3, 4) for discharge of metal powder above the base plate, and at least one laser element (5, 6, 7) for melting of discharged metal powder at certain points, wherein the carriage (1) has laser elements (5, 6) and material chambers (2, 3, 4) that alternate in the movement direction of the carriage (1), in an alternating sequence,
wherein the laser elements (5, 6) are formed by multiple lasers by means of which points below the carriage (1) can be irradiated over the entire width of the carriage, and a material chamber (2, 3, 4) or a material chamber arrangement composed of multiple material chambers extends over the entire width of the carriage (1) and has one or more discharge openings for discharging the metal powder kept on hand in the material chamber(s) (2, 3, 4) below the entire width of the carriage (1).

2. Apparatus according to claim 1, wherein the laser or lasers of a laser element (5, 6) either can themselves be adjusted in terms of direction or is/are oriented toward a deflection mirror that can be adjusted in terms of direction.

3. Apparatus according to claim 1, wherein at least one vibration element for uniformization of the material discharge is associated with the material chamber(s) (2, 3, 4).

4. Apparatus according to claim 3, wherein the at least one vibration element is an eccentric element or a piezoelectric vibration element.

5. Apparatus according to claim 1, wherein at least one imaging device that is oriented at the weld points (9) below the carriage (1) irradiated by the at least one laser element (5, 6) and data-connected with an evaluation apparatus is associated with the carriage (1).

6. Apparatus according to claim 1, wherein further laser elements (7) for point-type melting of discharged metal powder are disposed elevated above the base plate.

7. Method for the production of a three-dimensional metallic shaped body, wherein a carriage (1) that can be moved in a carriage guide above a base plate is provided with at least one material chamber (2, 3, 4) and discharges metal powder from the at least one material chamber (2, 3 4) while traversing the base plate, wherein a laser element (5, 6) adjacent to the at least one material chamber (2, 3, 4) is associated with the carriage (1), by means of which element the metal powder discharged above the base plate from the at least one material chamber (2, 3, 4) is melted at fusing points (9) above the base plate predetermined by a process computer data-connected with the laser elements (5, 6), and fused with surrounding material layers to produce a workpiece (8),
wherein the laser elements (5, 6) are formed by multiple lasers, by means of which lasers points below the carriage (1) are irradiated in the entire carriage width, and a material chamber (2, 3, 4) or a material chamber arrangement composed of multiple material chambers extends over the entire width of the carriage (1), and discharges metal powder kept on hand in the material chamber(s) (2, 3, 4) by means of one or more discharge openings under the entire width of the carriage (1).

8. Method according to claim 7, wherein during the course of traversing the base plate, material chambers (2, 3, 4) disposed parallel to one another discharge metal powder in multiple layers, which powder is melted between consecutive layers, by means of laser elements (5, 6) disposed between adjacent material chambers (2, 3, 4), and fused to surrounding material layers to produce a workpiece (8).

9. Method according to claim 7, wherein metal powder is fused in a region above the base plate that has already been completely traversed by the carriage (1), by means of additional laser elements (7) disposed elevated above the base plate.
